(19) United States
(12) Patent Application Publication
(10) Pub. No.: US 2017/0321656 A1
(43) Pub. Date: Nov. 9, 2017

(54) RENEWABLE ENERGY-DRIVEN CARBON CYCLE ECONOMIC AND ECOLOGICAL OPERATING SYSTEMS

(71) Applicants: Peter Eisenberger, New York, NY (US); Graciela Chichilnisky, New York, NY (US)

(72) Inventors: Peter Eisenberger, New York, NY (US); Graciela Chichilnisky, New York, NY (US)

(21) Appl. No.: 15/491,252

(22) Filed: Apr. 19, 2017

Related U.S. Application Data
(60) Provisional application No. 62/324,842, filed on Apr. 19, 2016.

(51) Int. Cl. F03D 9/00; C25B 1/04; C10L 1/04; H02S 10/10; C02F 1/44; F03D 9/25; F03D 9/11; F03B 13/10; C02F 103/08

(52) U.S. Cl. CPC F03D 9/007; F03D 9/11; C25B 1/04; C10L 1/04; F03B 13/10; H02S 10/10; C02F 1/441; F03D 9/25; C02F 2201/009; C02F 2103/08

(57) ABSTRACT

An integrated system for exploiting renewable energy sources based upon carbon dioxide captured from the atmosphere is provided, the system comprising: a solar energy collector; apparatus for capturing CO₂ from the atmosphere; a wind power driven electrical generator; water power driven electrical generator; electric power distribution control means from the renewable energy sources; energy storage systems; water desalinating means and water electrolysis means powered by the renewably generated electricity; hydrocarbon fuel preparation means utilizing the hydrogen and the carbon dioxide generated by this system; and a body of saline water adjacent the land on which the integrated system is built.

This application claims the benefit of priority pursuant to 35 U.S.C. 119(e) from a U.S. Provisional Patent Application having Application No. 62/324,842 filed Apr. 19, 2016, the text of which is fully incorporated by reference herein as if repeated below.

### BACKGROUND OF THE INVENTION

As most of the world has now recognized, the energy needs of the industrially developed countries, as well as that of the rest of the World that has not yet developed substantial industrial capacity, the World can no longer support its energy needs by relying upon fossil fuels such as petroleum, coal, and even natural gas, without destroying the environment. Moreover, with the ongoing industrial development in the less developed countries, it is to be expected that the worldwide rate of energy use, and therefore the rate of increase of carbon in the atmosphere, will increase.

To counter the effect of added carbon in the atmosphere scientists and engineers have conceived of and developed means to limit the exhaust of carbon into the atmosphere from the combustion of fossil fuels and have worked up systems to actually capture and remove CO₂ from the atmosphere. However, feedback systems have not heretofore been conceived, where materials are recycled for reuse, and CO₂ in the exhaust from combustion systems or in the atmosphere are recycled and used to produce goods and new fuels without requiring the exploitation of fossil fuels.

Although renewable energy resources such as solar power, wind, hydro power or geothermal power are in the process of being harnessed, even as part of a national power grid, a true recycling feedback system has not as yet been conceived. For example, solar energy has been harnessed by the use of photovoltaic cells and by the use of heat concentrating mirrors, to provide high temperature heat for the generation of steam for steam turbines or for chemical reactions. Hydropower, including dams and tidal mechanisms have been provided for the generation of electrical power. A self-maintaining recycle system, where the only recurring inputs are CO₂ and renewable energies, has not as yet been provided. This invention seeks to move beyond the present situation by providing a new ecology that does not result in dangerous effluent or exhaust to enter the World ecology.

### BRIEF SUMMARY OF THE INVENTION

It is an object of the present invention to provide an energy generation and management system which combines the exploitation of two or more renewable energy sources with two or more forms of energy storage and suitable control and distribution means to supply the full range of needs of an industrially developed community.

It is an object of this invention to provide a means to store the potential energy provided by natural renewable processes to enable a continuing utilization of that energy in a practical and efficient manner, and to desalinate sea water to provide salt-free water for that purpose. It is a further object of this invention to provide a variety of products from such a process having utility in fields other than energy usage. It is a further object of this invention to produce an efficient and clean-burning fuel for driving internal combustion engines.

In accordance with the present invention, an integrated process utilizing previously unrelated steps can be carried out in order to provide a means of storing, and thereby maintaining a constant flow of energy from, an intermittent renewable energy source such as the natural flow of wind, or the passage of sunlight during the daylight hours.

The present invention system meets these objectives by providing a blueprint for the combination of these processes and renewable resources in a specific geographic area, so that all of the advantages of renewable energy sources and the removal of carbon from the atmosphere can be enjoyed while improving the economic well-being of people on this planet.

### BRIEF DESCRIPTION OF THE SEVERAL VIEWS OF THE DRAWING

FIG. 1 depicts the overall combination of renewable energies, CO₂ capture and suitable industrial and agricultural activities that can economically be followed.

FIG. 2 depicts a specific proposed industrial cluster.

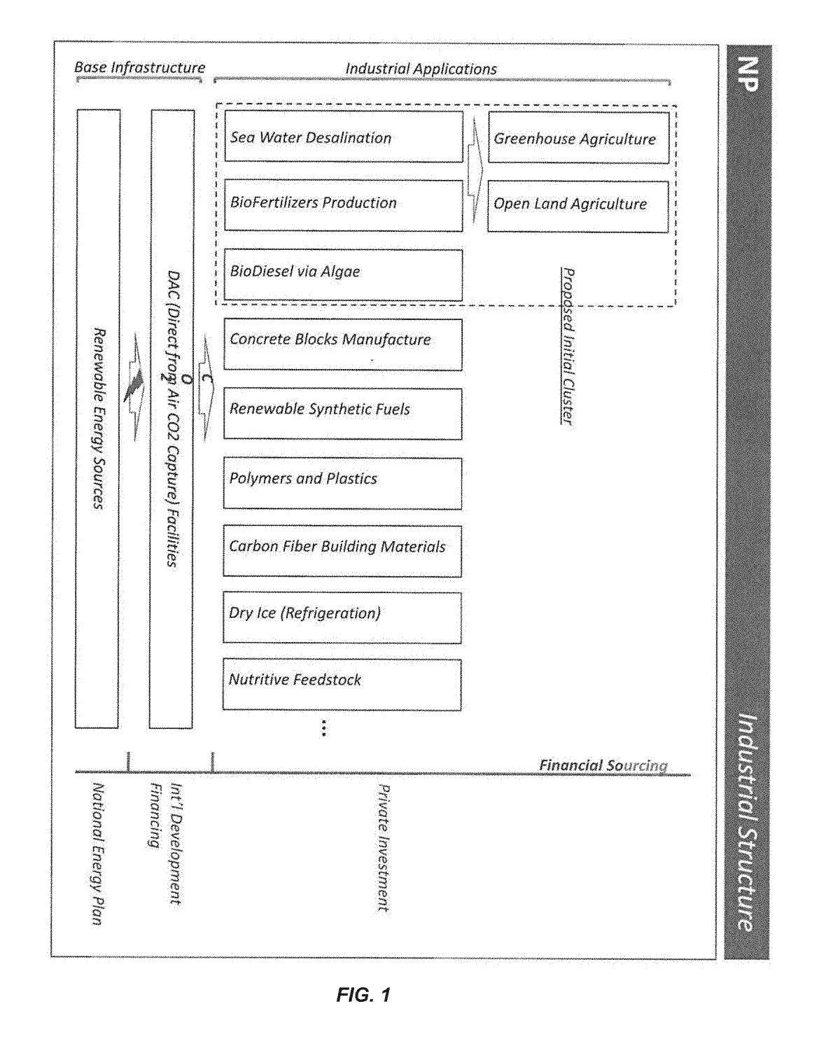

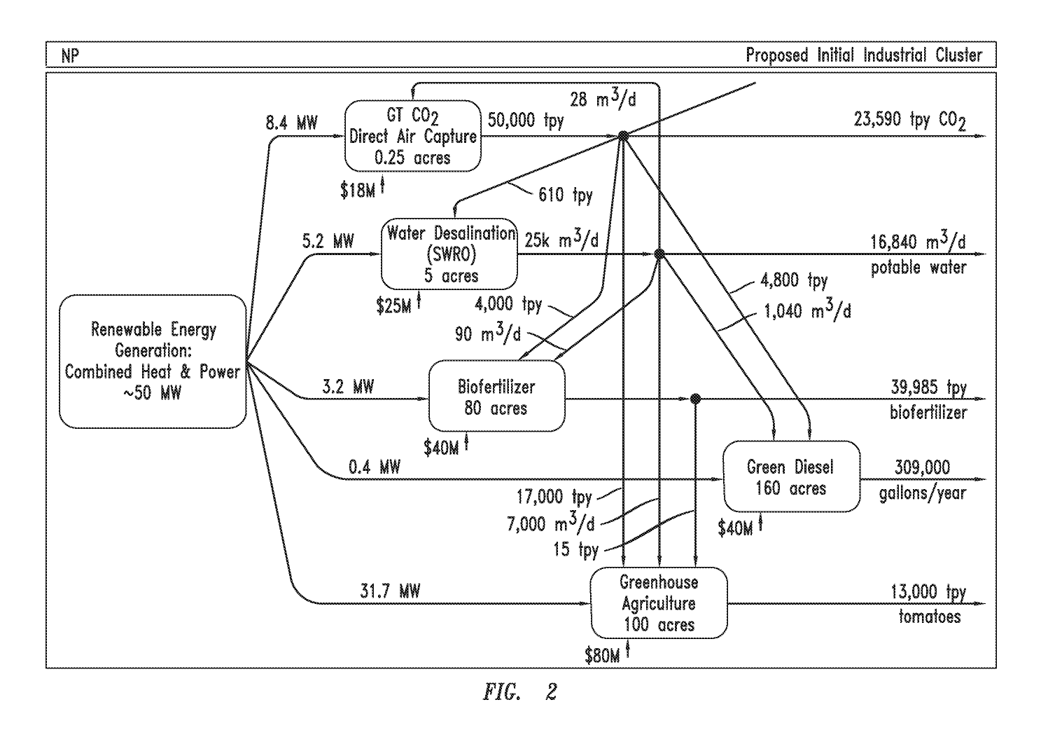

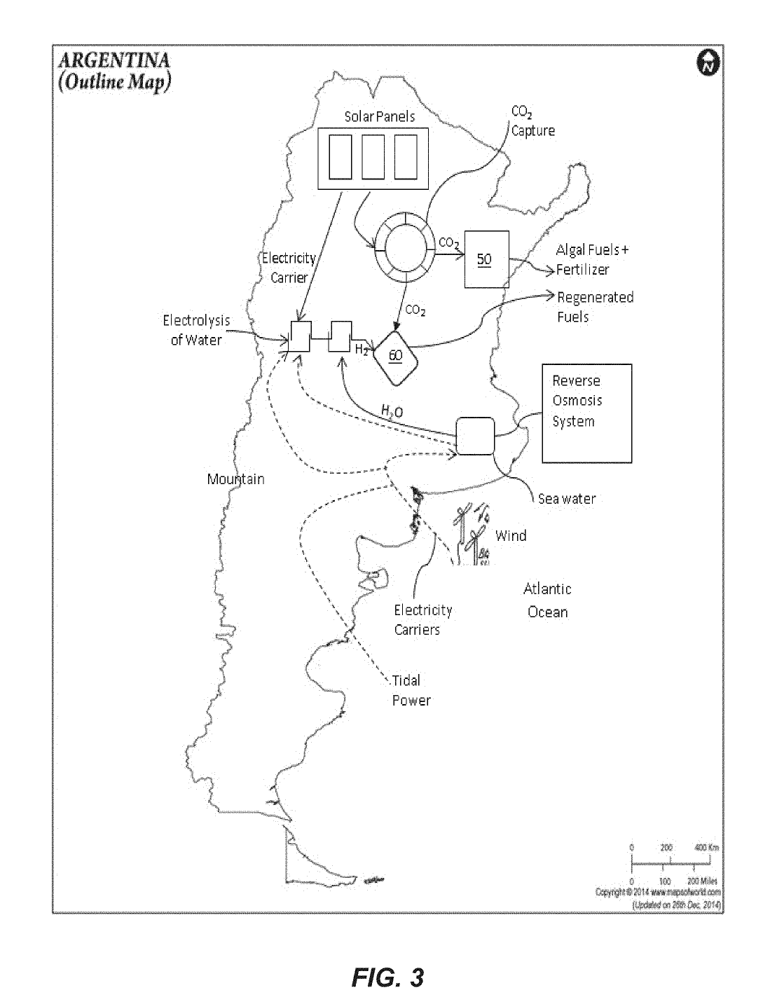

Argentina has been used as an example of a suitable location for such a geographic region, in FIG. 3.

### DETAILED DESCRIPTION OF THE INVENTION

This invention utilizes a combination of the various forms of renewable power generation from naturally occurring energy, and a system to capture and store CO₂ from the atmosphere to provide for an ongoing, self-supporting system that will provide the needs of a large coherent area without despoiling the environment with its waste products. Utilizing a combination of different renewable energy systems provides for power under every condition, so that it compensates for the fact that solar power is lost at night or reduced by cloud cover; the availability of wind power is subject to the presence of wind in excess of the minimum velocity required to operate the equipment which often occurs when solar energy is most available; and the providing of hydropower, both by the use of dams and mechanisms for tapping tidal power, can result in a system where substantially full time power becomes available without degradation of the environment.

One example of a preferred system to capture and store CO₂ from the atmosphere is described in U.S. Patent Publication No. US 2015/0273385, dated Oct. 1, 2015, the disclosure of which is incorporated herein as if fully repeated herein.

Solar energy can be collected as electricity using any of the well-known solar panels, which convert sunlight directly to electricity. Alternatively, solar heat can be used to generate steam from water or to carry out phase changes on, for example, solid salt solutions, which are also well-known in the literature. Electricity can be generated from wind power hydropower, from flowing water, or from tidal movements, using any of the well-known windmill or wind or water turbine generators, all well-known in the art. All of these systems are being systematically developed further and any of the future developments more efficiently generating electricity from natural forces can be utilized.

Moreover, for those few times when none of the renewable energy sources is available in sufficient amounts, the providing of storage means can take up the slack. For example, electricity can be stored during those times when the solar, wind or hydropower is high, by for example the charging and use of batteries to store electricity directly, or by the preparation of and storage of hydrogen from water, when electricity from other renewable sources are at their peak of availability.

In addition, alternative fuels, as well as various types of construction materials, can be prepared from the CO₂ captured from the atmosphere or from exhaust stacks, which also is renewable in the sense that the CO₂ generated from the combustion of such alternative fuels can then be recycled and used to regenerate such fuels when the renewable systems are again generating at high levels.

As a result of the combinations of the present invention, the inevitable variations in power level and interruptions in power supply that had made solar power, hydropower and wind power, each individually undesirable as the principal power source for an industrially developed community, need no longer be an excuse to not develop such systems in combination, together with the storage means discussed herein. Such concern is no longer valid as a result of this invention.

In accordance with the present invention, a Human Designed Carbon Cycle, run by Renewable Energy (HDCCRRE) can now be implemented, which can enable a Renewable Energy and Materials Economy (REME) that can now:
1. provide energy security;
2. increase global prosperity so that global equity can be achieved;
3. significantly mitigate the environmental degradation, due to mining or other resource extraction; and
4. remove the threat of climate change.

A renewable energy and materials economy (REME) can be provided by carrying out the above generally described human designed carbon cycle run by renewable energy (HDCCRRE) by utilizing three presently accessible technologies. Well known systems of providing renewable energy, whether it is from wind, solar, or hydropower, are available today and have been used on a sufficient scale that it is part of the electrical power grid in many developed countries, including the United States and Germany. The system also requires the capture and storage from the atmosphere as well as from any potential effluent exhaust of carbon dioxide, which is also available today in commercially and economically accessible methods, as described herein.

The carbon dioxide thus captured from the atmosphere, together with hydrogen obtained by the renewable energy electrolysis of water, can be combined to produce renewable liquid fuels, shown as item “50” and “60” in the drawing of FIG. 3, for the transportation sector, as well as hydrocarbon-based chemicals, pharmaceuticals and polymers. Carbon dioxide captured from the air can be utilized for the manufacture of carbon intensive building materials replacing in many cases metals and concrete, enabling the removal and sequestering of carbon from the air while hopefully forestalling the environmental degradation created by the mining of either fossil fuels or metal ores, or by the burning of extracted hydrocarbon fuels. The combined utilization of these technologies will enable a positive feedback loop between meeting the needs of humans on this planet even as the total population grows, together with environmental improvements and long-term sustainability.

By utilizing the feedback loop inherent in the use of the several complementary technologies, in the manner described under this invention, the more energy that is used, and the more materials that are used, the more the environment improves by virtue of the capture and removal of carbon from the atmosphere. This results in returning the planet to the climate system it would have achieved without the intervention of human activity. This is contrary to the present system utilizing fossil fuels as the primary energy source where the more energy that is consumed, the more environmental degradation will occur.

Thus, for example, solar energy can be used to produce desalinated water, capture CO₂ from the air and concentrate the CO₂ and to then drive the reactions to be used to convert the carbon dioxide and hydrogen, obtained by virtue of the electrolysis of desalinated water, into the energy, fertilizer, fuels for mobile use, and the building materials required for human existence. Indeed, to the extent that the system manages to improve the human condition to a place where all are provided with their needs and beyond, a potentially cooperative system is likely to emerge where the system is operated in such a manner as to maintain the climate of the air in a condition most suitable for human existence and comfort.

As will be shown by the carrying out of the system in accordance with this invention by providing sufficient renewable energy by the use of solar energy, hydropower and wind power and the removal of CO₂ from the atmosphere, a sustainable and highly successful economic development, energy security, addressing of a climate change threat and the reducing of environmental impacts from natural resource use can all be accomplished while at the same time resulting in a greater profit for all of humanity,

From the inputs of renewable energy, sea water and CO₂ from the air, the following can be achieved: enhanced productivity of agriculture; renewable production of chemicals, plastics and polymers; the renewable production of liquid fuels without requiring exploitation of natural resources other than cited above; as much portable water as can be required for human use and for the planet can be achieved; and the materials of construction can be provided without the usual degradation of the environment resulting from removal of, for example, metallic minerals from the earth. Such a system can be provided in substantially all parts of the world without creating the cycles of feast or famine that exist today, exploiting the present natural resources for providing economic growth.

By providing the combination of technologies forming the basis for the present invention, not only will enhanced productivity be achieved in all areas including agriculture and industry. Productivity will also be more generally distributed throughout the world, including those areas that presently suffer from overheating of the climate and lack of water. These problems will be greatly lessened, or become obsolete, when ocean water can be used following desalination, utilizing substantially free energy from the sun and the wind and water without having to provide fossil fuels, which are not as generally distributed worldwide for human use.

The initial basis for such a potential economy of scale is the capture and storage of CO₂ from the atmosphere as part of not only a new economy but also to reduce the problem of climate change from the increased excess of CO₂ presently in the atmosphere. Combining the newly available CO₂ raw material with a renewable energy source, such as solar energy whether by the direct generation of electricity from solar panels or the use of the sun's heat energy; sufficient heat can be generated from the sun's rays to form a high temperature source, would be available throughout at least the temperate and tropical parts of the earth. In addition, wind energy and hydropower are also renewable energy systems that can contribute to this effect, and would be even more widely distributed.

Although the coastal areas will be the immediate, direct beneficiaries of the combined systems of the present invention, it is clear that there are sufficient coastal areas available to most countries that a useful exchange can be provided. Water can be more safely transported instead of oil in pipelines or by railroads, and where the solar energy and hydropower available in many inland areas, for example, desert regions where solar light is available during a large proportion of the year, can be brought to the coastal regions, via high voltage carrier lines.

A useful combination of initial industry and supply can be provided for example in the southern part of the country of Argentina where there is a significant and substantial sea coast area that is available to all with regard to renewable energy production by wind and solar energies and potentially by the harnessing of tidal power, for the desalination of ocean water. Using this renewable energy for example at a cost of $0.02-0.03 U.S. per kilowatt hour and heat energy for under $0.01 US per kilowatt hour, would enable the operation of a large process for capturing CO₂ from the air at a cost of not greater than $25-$50 USD per tonne, and processes utilizing solar or hydropower electricity can provide hydrogen at from $1 to $1.50 per kilogram of the gas and will provide sufficient power to pressurize the hydrogen to reach sufficient density that would make storage economical. Synthetic fuels and polymers can be prepared by the use of the solar or water-derived electricity generation, or by the use of algae or other microbes, often times specifically tailored to form the desired product from CO₂.

That availability of CO₂ and hydrogen will allow for the production of liquid synthetic fuels from the CO₂ and hydrogen utilizing again the energy from the renewable systems at a cost of around $3 per gallon. Although this is a cost greater than is presently available for fossil fuels, the fossil fuels as presently costed, do not include the social and human cost of increasing CO₂ in the atmosphere and thereby causing drastic climate change, and other environmental degradation, which would result in further dislocation of the human population, the cost difference is minimal.

Similarly, carbon fiber based construction materials, again prepared utilizing CO₂ captured from the air, will be available at a cost competitive to the cost for large scale construction presently utilizing steel, aluminum and concrete.

The initial technology for extracting CO₂ from the atmosphere is described, for example, in U.S. Pat. Nos. 9,061,237 and 8,894,747, and pending applications, all by present applicants. A specific apparatus and methodology for achieving an efficient capture of CO₂ from the atmosphere is described in US Patent Publication No. US-2015-0273385-A1. These and the other applications and patents issued to these inventors provide a good background with regard to the opportunity to obtain and capture CO₂ directly from the atmosphere, and are incorporated herein as if fully repeated herein.

It is also known to desalinate ocean water and to generate hydrogen from the desalinated water by electrolysis, i.e., utilizing electrical energy from solar energy or from hydropower. An economically and commercially useful system is the reverse osmosis process to obtain fresh water from sea water, for example as developed by Veolia Eau, a French company, e.g., as described in U.S. Pat. Nos. 7,216,529, and 9,126,149; as well as by General Electric Corporation, as described, for example, in U.S. Pat. Nos. 8,021,550 and 9,266,762. Many other systems are also available and useful in this system.

The CO₂ product from the atmospheric removal system is useful for the production of a biofertilizer by the production of algae, or other microbials, for example as is disclosed in U.S. Patent Publication US-2014-0345341, which also provides for the production of fuels utilizing the system,

The CO₂ captured and stored from the atmosphere has also been used to prepare various polymers and plastics, such as polyethylene, polypropylene and polycarbonate, utilizing microorganisms, such as is described in U.S. Pat. Nos. 9,040,267 and 9,085,784.

Ecologically protective concrete materials can be manufactured by sequestering the CO₂ into the mixture as is described in U.S. Pat. Nos. 8,845,940 and 9,108,883.

Finally, in the combination of the present invention, the CO₂ captured directly from the atmosphere can be used in the production of important structural strengthening materials such as carbon fibers and graphene, as is shown, for example, in U.S. Pat. No. 9,260,308.

It is also well known to produce methanol using hydrogen and an oxide of carbon, i.e., carbon monoxide or carbon dioxide.

Patentable embodiments of this invention which are claimed are as following:

1. An integrated system for exploiting renewable energy sources while removing carbon from the atmosphere, the system comprising:
(a) a solar energy collector;
(b) apparatus for carrying out a process for capturing and storing CO₂ from the atmosphere;
(c) a wind power driven electrical generator;
(d) water power driven electrical generator means;
(e) electric power distribution control means controlling and/or combining electrical energy obtained from the renewable energy sources
(f) energy storage systems selected from the group consisting of electrical storage batteries, hydrogen fuel storage, liquid hydrocarbon fuel storage and heat-insulated storage means for holding extremely hot liquid, for storing renewable energy;
(g) desalinating means;
(h) water electrolysis means for the generation of hydrogen gas from the desalinated water; the electrolysis means and the desalinating means being powered by the renewably generated electricity;
(i) hydrocarbon fuel means utilizing the hydrogen and the carbon dioxide generated by this system; and
(j) a body of saline water adjacent the integrated system.

2. The integrated system of claim 1 wherein the solar energy collector is a solar panel to convert sunlight to electricity.

3. The integrated system of claim 1 wherein the solar energy collector is a solar heat collector based upon the boiling of water or the phase change from heating a solid salt mixture to above its melting point, to use the heat to generate electricity.

4. The integrated system of claim 3 further comprising storing at least a portion of the molten salt to generate electricity when the sun is no longer shining.

5. The integrated system of claim 1 wherein the ocean is the body of saline water located adjacent at least the desalinating means of the integrated system.

6. The integrated system of claim 1 further comprising a regenerated fuel burning electric generator.

7. The integrated system of claim 1 wherein the system to capture and store CO₂ from the atmosphere comprises a rotating multi-monolith bed movement system for removing CO₂ from the atmosphere.

8. The integrated system of claim 1 wherein the solar energy collector is a solar panel to convert sunlight to electricity.
